(19) United States
(12) Patent Application Publication
(10) Pub. No.: US 2002/0079662 A1
(43) Pub. Date: Jun. 27, 2002

(54) Brake/shock-absorber seat structure of handle-controlled skate board

(76) Inventor: James Lee, Changhua (TW)

Correspondence Address: BACON & THOMAS, 4th Floor, 625 Slaters Lane, Alexandria, VA, 22314, US

(21) Appl. No.: 09/741,058

(22) Filed: Dec. 21, 2000

(51) Int. Cl. B62M 1/00

(52) U.S. Cl. 280/87.041; 280/11.28; 188/19

(57) ABSTRACT

Brake/shock-absorber seat structure of handle-controlled skate board. The front ends of rear wheel brackets are pivotally connected with a lower bar of rear section of the skate board by a shaft pin. The bottoms of front sections of the rear wheel brackets are connected by a connecting plate. A projecting circular receptacle is formed in the connecting plate. The rear wheel brackets are formed with through holes behind the receptacle. A rear wheel is pivotally connected with the rear portions of the rear wheel brackets. The wheel cover is locked on the middle portion and rear end of the rear wheel brackets. The middle portion of the wheel cover is equipped with a brake structure. One end of the shock-absorbing spring abuts against the bottom face of the skate board. The other end thereof is received in the receptacle of the connecting plate of the rear wheel brackets. The restricting slide rail is locked on the locking plates of the skate board. A lower section of the slide rail is formed with a blind arch rail slot. A pin member is passed through the through holes of the rear wheel brackets and the slide slot of the restricting slide rail. The rear wheel brackets are movable through an arch path along the rail slot of the restricting slide rail about the shaft pin at front end of the rear wheel brackets, whereby the rear wheel brackets can only move up and down without deflecting left or right so as to achieve a true shock-absorbing effect.

### BACKGROUND OF THE INVENTION

The present invention is related to a brake/shock-absorber seat structure of handle-controlled skate board. The rear wheel brackets are movable through an arch path along the rail slot of the restricting slide rail about the shaft pin at front end of the rear wheel brackets, whereby the rear wheel brackets can only move up and down without deflecting left or right so as to achieve a true shock-absorbing effect. Also, the up and down shock coming from the rear wheel can be effectively reduced. In addition, the shock-absorbing structure can bear heavy load to enhance the comfort during riding.

FIG. 1 shows the shock-absorber of rear wheel of a conventional handle-controlled skate board 90. A pivot bracket 92 projects from the bottom of rear section of the skate board 91. A shaft rod 93 is riveted with the bottom end of the pivot bracket 92. A rear wheel 94 is pivotally connected with the end of the shaft rod 93. The rear wheel 94 can be inward folded by a certain angle via the shaft rod 93. A shock-absorber 95 is welded at rear end of the skate board 91 for stopping the shaft rod 93 of the rear wheel 94. The upper and lower sides of the shock-absorber 95 are respectively fitted with stop posts 951, 952. The upper stop post 951 is welded under the rear end of the skate board 91. A spring 953 is compressed between the two stop posts 951, 952. The spring 953 can be replaced by an oil cylinder or buffer rubber block. When riding the handle-controlled skate board, the rear wheel 94 will drive the shaft rod 93 to lean on the lower stop post 952 of the shock-absorber 95 to move up and down. At this time, the spring 953 is compressed or restored for absorbing shock.

The conventional structure has some shortcomings as follows:

1. When the rear wheel 94 runs over an irregular road face, the rear wheel 94 will drive the shaft rod 93 to deflect up and down by a certain angle. The shaft rod 93 will lean on and push the lower stop post 952 to move up and down. The lower stop post 952 is only fitted with the lower side of the shock-absorber 95 without any locating means so that the lower stop post 952 can be deflected up and down and left and right. As a result, when the shaft rod 93 pushes the lower stop post 952, the application force is often uneven and fails to be directed to the center. This will make the lower stop post 952 to deflect left and right as shown in FIG. 1. It often takes place that the lower stop post 952 clogs and fails to move up and down. Therefore, the shock-absorber will lose its shock-absorbing function.

2. In case of clogging of the lower stop post 952 during riding, the rear wheel 94 will be unable to buffer the vertical shocking force. This will make the rider uncomfortable during riding.

### SUMMARY OF THE INVENTION

It is therefore a primary object of the present invention to provide a brake/shock-absorber seat structure of handle-controlled skate board. The pin member is movable through an arch path along the rail slot of the restricting slide rail about the shaft pin at front end of the rear wheel brackets, whereby the rear wheel brackets can only move up and down without deflecting left or right. Therefore, a true shock-absorbing effect can be achieved and the up and down shock coming from the rear wheel can be effectively reduced. In addition, the shock-absorbing structure can bear heavy load to enhance the comfort during riding.

It is a further object of the present invention to provide the above brake/shock-absorber seat structure in which the wheel cover is locked with the rear wheel brackets, whereby the rear ends of the rear wheel brackets have a supporting point where a user's foot can rest. The supporting point also serves as a spacing for controlling the brake.

It is still a further object of the present invention to provide the above brake/shock-absorber seat structure in which the pedal is connected with the brake block. When braking, the braking face of the brake block embraces and attaches to the rim of the rear wheel so as to achieve a fully braking effect.

The present invention can be best understood through the following description and accompanying drawings wherein:

### BRIEF DESCRIPTION OF THE DRAWINGS

FIG. 1 is a partially sectional view of the shock-absorber structure of rear wheel of a conventional handle-controlled skate board, showing the operation thereof;

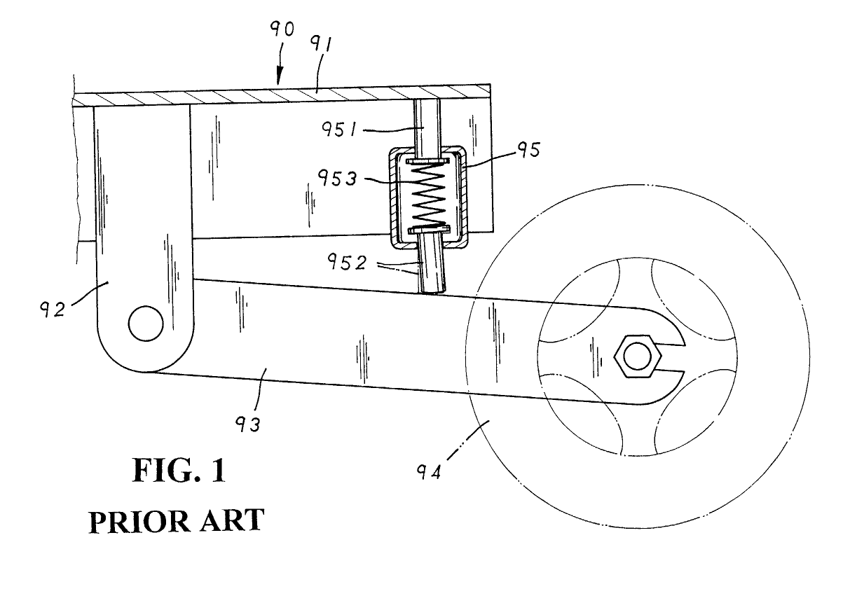

FIG. 2 is a perspective exploded view of the present invention;

FIG. 3 is a sectional assembled view of the present invention, showing the operation thereof; and

FIG. 4 is a rear sectional view of the present invention, showing the operation thereof.

### DETAILED DESCRIPTION OF THE PREFER EMBODIMENT

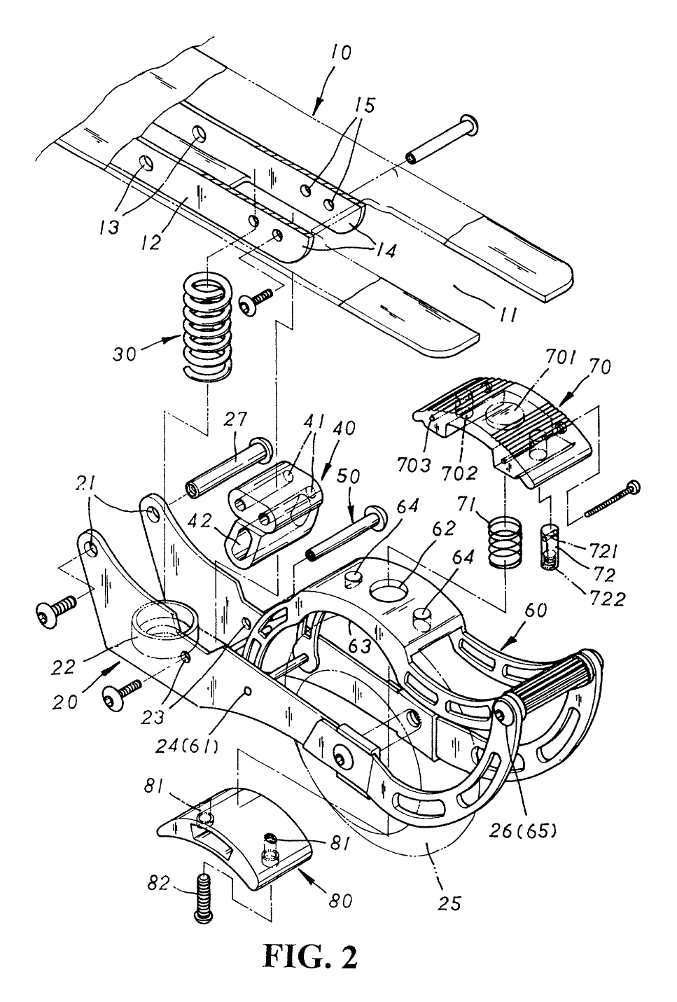

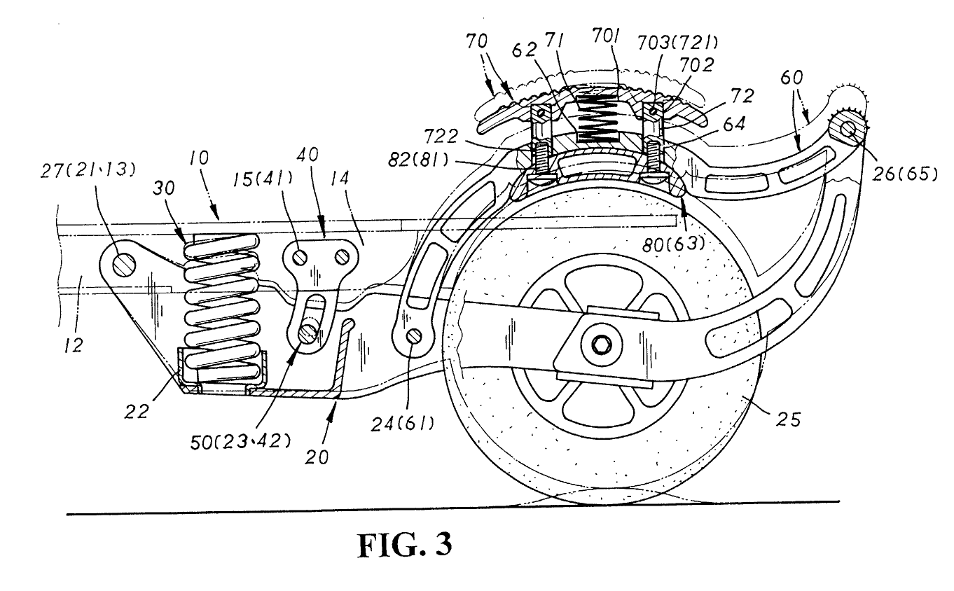

Please refer to FIGS. 2 and 3. The brake/shock-absorber seat structure of the present invention is installed on rear section of the skate board 10 of the handle-controlled skate board. The present invention includes:

a skate board 10, a rear section of the skate board 10 being cut with an escape split 11 for avoiding the rear wheel 25 and wheel cover 60, a middle portion of a lower bar 12 of the skate board 10 being formed with shaft holes 13, a rear portion of the lower bar 12 being cut with a split, whereby two sides of the split define two locking plates 14 each having two locking holes 15;

two symmetrical rear wheel brackets 20, a front end of each rear wheel bracket 20 being formed with a shaft hole 21, a shaft pin 27 being passed through the shaft holes 21 and the shaft holes 13 of the skate board 10 to pivotally connect the rear wheel brackets 20 with the skate board 10, a rear portion of the rear wheel bracket extending rearward by a certain length and then turning upward, the bottoms of front sections of the two rear wheel brackets 20 being connected by a connecting plate, a projecting circular receptacle 22 being formed in the connecting plate, the two rear wheel brackets 20 being formed with through holes 23 behind the receptacle 22, the middle port ions of the rear wheel brackets 20 are formed with locking holes 24, the rear wheel 25 being pivotally connected with the rear portions of the rear wheel brackets 20, the rear ends thereof being formed with locking holes 26;

a shock-absorbing spring 30 installed in the split of the skate board 10, one end of the spring 30 abutting against the bottom face of the skate board 10, the other end thereof being received in the receptacle 22 of the rear wheel brackets 20 for absorbing the shock coming from the rear wheel 25 and bearing heavy load;

a restricting slide rail 40, an upper portion thereof being formed with two locking holes 41, screws being passed through the locking holes 41 to lock the slide rail 40 at the locking holes 15 of the locking plates 14 of the skate board 10, a lower portion thereof being formed with a blind arch rail slot 42;

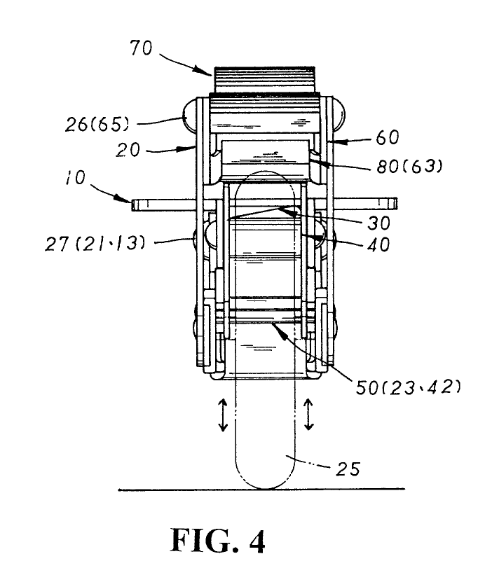

a pin member 50 passed through the through holes 23 of the rear wheel brackets 20 and the rail slot 42 of the restricting slide rail 40, the pin member 50 being movable through an arch path along the rail slot 42 about the shaft pin 27 at front end of the rear wheel brackets 20, whereby the rear wheel brackets 20 can only move up and down without deflecting left or right ( as shown in FIG. 4 );

a wheel cover 60 disposed between the escape split 11 of the skate board 10 and the two rear wheel brackets 20, a front end of the wheel cover 60 being formed with a bulge section having a locking hole 61, screw being passed through the locking hole 61 to lock the wheel cover at the locking holes 24 of the rear wheel brackets 20, a rear portion of the wheel cover extending rearward to form an arch shape opposite to the rear wheel 25 and then turning upward, the top face of middle portion being formed with a dent 62, the bottom face being formed with an arch locating recess 63 opposite to the brake block 80, the front and rear sides of the locating recess 63 being formed with through holes 64, the rear end of the wheel cover 60 being formed with a bulge section having a locking hole 65, screw being passed through the locking hole 65 to lock the wheel cover at the locking holes 26 of the rear ends of the rear wheel brackets 20;

a pedal 70 which is an arch body disposed above the center of the wheel cover 60, an upper surface thereof being formed with slipproof stripes, the bottom face being formed with a central recess 701, the front and rear sides being formed with sockets 702 with a certain depth, a thread hole 703 being transversely formed through the socket 702;

a restoring spring 71 compressed between the pedal 70 and the wheel cover 60, one end of the restoring spring 71 being received in the recess 701 of the pedal 70, the other end thereof being received in the dent 62 of the wheel cover 60, the restoring spring 71 serving to restore the pedal 70 to its home position after trod;

two connecting rods 72, the upper end sections thereof being respectively inserted in the sockets 702 of front and rear sides of the pedal 70 and formed with transverse thread holes 721, screws being screwed into the thread holes 721 and the thread holes 703 of the pedal 70 to lock the connecting rods 72 with the pedal 70, the lower sections thereof being fitted through the through holes 64 of the wheel cover 60, the bottom faces being recessed and formed with locking holes 722; and

a hollow brake block 80 disposed in the locating recess 63 of the wheel cover 60, the bottom face being formed with an arch brake face opposite to the rear wheel 25, the front and rear sides being formed with locking holes 81, screws 82 being screwed into the locking holes 81 to lock the brake block 80 at the locking holes 722 of the bottom face of the connecting rods 72. The restoring spring 71 is compressed to a certain extent, making the pedal 70 and the brake block 80 integrally locked together. The brake block 80 is spaced from the rim of the rear wheel 25 by a certain distance.

With the restoring spring 71 compressed or restored, the pedal 70 can directly drive the brake block 80 to move up and down for braking.

According to the above arrangement, the present invention has the following advantages:

1. The pin member 50 is movable through an arch path along the rail slot 42 of the restricting slide rail 40 about the shaft pin 27 at front end of the rear wheel brackets 20, whereby the rear wheel brackets 20 can only move up and down without deflecting left or right (as shown in FIG. 4). Therefore, a true shock-absorbing effect can be achieved and the up and down shock coming from the rear wheel 25 can be effectively reduced. In additions the shock-absorbing structure can bear heavy load to enhance the comfort during riding.

2. The wheel cover 60 is locked with the rear wheel brackets 20, whereby the rear ends of the rear wheel brackets 20 have a supporting point where a user's foot can rest. The supporting point also serves as a spacing for controlling the brake.

3. The pedal 70 is connected with the brake block 80. When braking, the braking face of the brake block 80 embraces and attaches to the rim of the rear wheel so as to achieve a fully braking effect.

The above embodiment is only used to illustrate the present invention, not intended to limit the scope thereof. Many modifications of the above embodiment can be made without departing from the spirit of the present invention.

What is claimed is:

1. Brake/shock-absorber seat structure of handle-controlled skate board, the brake/shock-absorber seat structure being installed on a rear section of the skate board of the handle-controlled skate board, comprising:
a skate board, a rear section of the skate board being cut with an escape split, a middle portion of a lower bar of the skate board being formed with shaft holes, a rear portion of the lower bar being cut with a split, whereby two sides of the split define two locking plates each having locking holes;
two rear wheel brackets, a front end of each rear wheel bracket being formed with a shaft hole, the bottoms of front sections of the two rear wheel brackets being connected by a connecting plate, a projecting circular receptacle being formed in the connecting plate, the two rear wheel brackets being formed with through holes behind the receptacle, a rear wheel being pivotally connected with the rear portions of the rear wheel brackets; and
a shock-absorbing spring, one end of the spring abutting against the bottom face of the skate board, the other end thereof being received in the receptacle of the connecting plate of the rear wheel brackets, whereby the front ends of the rear wheel brackets are pivotally disposed at the shaft holes of the skate board by the shaft pin, a restricting slide rail being locked on the locking plates of the skate board, a pin member being passed through the through holes of the rear wheel brackets and the slide slot of the restricting slide rail, the pin member being movable through an arch path along the rail slot of the restricting slide rail about the shaft pin at front end of the rear wheel brackets, whereby the rear wheel brackets can only move up and down without deflecting left or right so as to achieve a true shock-absorbing effect to reduce the up and down shock coming from the rear wheel.

2. Brake/shock-absorber seat structure of handle-controlled skate board as claimed in claim 1, wherein the middle portions of the rear wheel brackets are formed with locking holes and the rear ends thereof are formed with locking holes, said brake/shock-absorber seat structure further comprising:
a wheel cover, a front end and a rear end of the wheel cover being formed with locking holes, a top face of middle portion being formed with a dent, the bottom face being formed with an arch locating recess opposite to the brake block, the front and rear sides of the locating recess being formed with through holes;
a pedal disposed above the center of the wheel cover, the bottom face of the pedal being formed with a central recess, the front and rear sides being formed with sockets with a certain depth, a thread hole being transversely formed through the socket;
a restoring spring compressed between the pedal and the wheel cover, one end of the restoring spring being received in the recess of the pedal, the other end thereof being received in the dent of the wheel cover;
two connecting rods, upper end sections thereof being respectively inserted in the sockets of the pedal and formed with transverse thread holes, bottom faces of the connecting rods being recessed and formed with locking holes; and
a brake block disposed in the locating recess of the wheel cover, the bottom face of the brake block being formed with an arch brake face opposite to the rear wheel, the front and rear sides being formed with locking holes, whereby the wheel cover is disposed between the escape split of the skate board and the two rear wheel brackets, two ends of the wheel cover being locked on the middle portion and rear end of the rear wheel brackets, the connecting rods being passed through the through holes of the wheel cover to integrally lock the pedal with the brake block on front and rear sides, the restoring spring being compressed to a certain extent, whereby the brake block is spaced from the rim of the rear wheel by a certain distance, with the restoring spring compressed or restored, the pedal can directly drive the brake block to move up and down for braking.
